(19) United States
(12) Patent Application Publication
(10) Pub. No.: US 2002/0178452 A1
(43) Pub. Date: Nov. 28, 2002

(54) IN-HOME NETWORK FOR DISTRIBUTING DATA

(76) Inventor: DANIEL LECOMTE, PARIS (FR)

Correspondence Address: SUGHRUE MION ZINN MACPEAK & SEAS PLLC, 2100 PENNSYLVANIA AVENUE N W, WASHINGTON, DC, 200373213

(21) Appl. No.: 09/335,846

(22) Filed: Jun. 18, 1999

(30) Foreign Application Priority Data
Jun. 22, 1998 (EP) 98 440 138.0

(51) Int. Cl. H04N 7/18; H04N 7/173

(52) U.S. Cl. 725/78; 725/74; 725/110

(57) ABSTRACT

An in-home network for distributing data is provided comprising a set-top box for connecting the in-home network to the access network. The set-top box includes memory units for storing configuration data from the access network and is connected on the home side via a digital broadband matrix to a control unit.

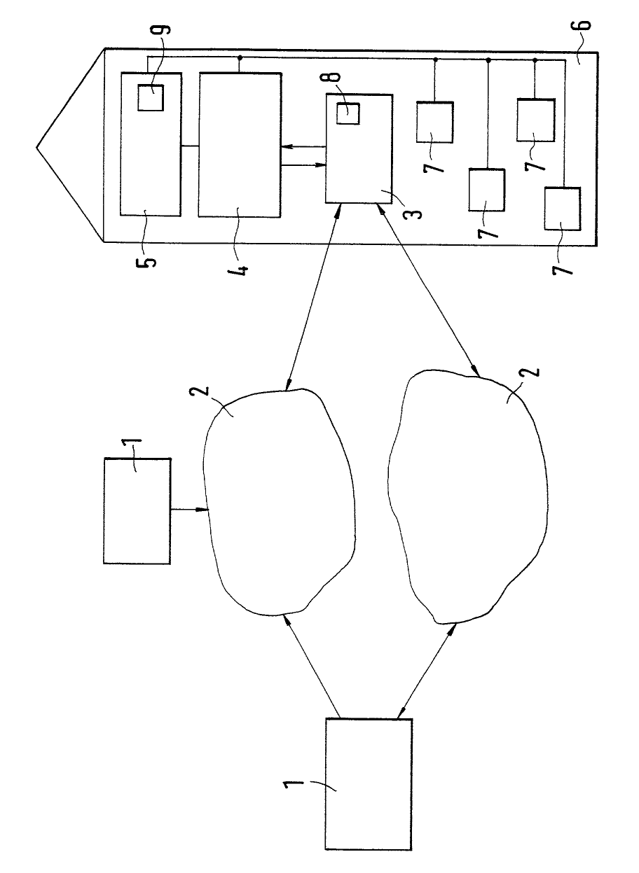

This invention relates to an in-home network for distributing data, generally video, or audio, or control data, as set forth in the preamble of the main claim.

DE 44 35 766 A1 discloses an in-home network for distributing video and audio signals which additionally permits bidirectional transmission of subscriber-related signals. In the future, the existing networks for distributing video and/or audio signals over coaxial cables up to the subscriber are to be used also for the transmission of subscriber-related digital signals. Examples of such interactive services are video-on-demand, teleshopping, and further multimedia applications. To accomplish this, it will be necessary to transmiff, besides the signals from a center to the subscribers, signals from the subscribers to the center. To connect the in-house networks to the access network, which, in turn, is connected to the center, so-called set-top boxes are used. Such set-top boxes contain modulators and decoders, so that the signals from the access network can be received and decoded. They generally have a control panel through which they can be put in a given operating condition.

Such in-home networks with conventional set-top boxes have the disadvantage that the demodulators and decoders of the set-top box are adapted to the offer of one network provider. From the standpoint of the provider it is understandable that the set-top boxes are designed only for the reception of one specific system. For the customer, however, this situation is unsatisfactory since a conventional set-top box does not readily permit access to new information services or a change to another provider. The in-home network according to the invention, with the characterizing features of the main claim, has the advantage that an “open” set-top box is provided which comprises memory units suitable for storing configuration data, so that individual system providers can load configuration data from the access networks into the set-top box and permit decoding and demodulation. Additional flexibility of the in-home network is provided by the connection of the set-top box with a digital broadband matrix. This matrix expands the capabilities of the set-top box as it can be connected to a control unit and/or to different output devices, such as screen devices.

By the measures recited in the subclaims, an improvement of the in-house network claimed in the main claim is possible. Particularly advantageously, the broadband matrix is connected to a control unit in the form of a server. By this, the flexible use is extended for all possible functions in the in-home network. Advantageously, the server has connections for a variety for output and input devices, and different control functions of the in-home technology are incorporated into the server.

Furthermore, it is readily possible to control access to the in-home network via an input/output device in the form of a card reader and a smart card.

An embodiment of the invention is illustrated in the accompanying drawing and will now be explained in more detail.

The single FIGURE of the drawing is a schematic representation of an in-home network according to the invention and an access network system.

Via head ends 1, which feed different data into access networks 2, the data are passed on to a subscriber location 6. The access networks 2 are connected to a set-top box 3. The set-top box 3 includes a memory unit 8 and is connected via a digital matrix 4 to a server 5. The server serves as a control unit for devices 7, which may be input/output devices. The system is a return-channel-capable broadband communications system which makes available interactive services, such as video-on-demand, home banking, teleshopping, etc. A basis for such a communications system may be a cable television network, a sattelite access or an integrated services network such as ISDN. Television and radio programs, for example, are feed from a head end 1 into the distribution network, for example an access network 2, and transmitted to a plurality of subscribers 6. In addition, in response to a request from a subscriber 6, video and audio signals are fed from the head end into the network and transmitted to the subscriber. The request signals are transmitted over the same access network or alternatively over another one. The set-top box serves to receive television and radio programs as well as further video and audio signals which are transmitted through the access network. The set-top box 3 contains demodulating and decoding devices for converting the signals received from the access network. These devices serve to filter out those of the received video and audio signals which are desired by the subscriber. The processing of these signals includes decompressing, demodulating, decoding, and decrypting the signals. The signals may be compressed and/or modulated quite differently. Depending on the provider of the programs, different codes may be present. To make it easier for the subscriber to access different networks, the set-top box includes a memory unit 8 which is specifically designed to store configuration data of the provider.

When the set-top box according to the invention is installed, it has no information on how the data to be received are compressed and modulated. The subscriber will then communicate his or her wish through the access networks to a provider which, in turn, will send the necessary configuration data to the set-top box. There, these initialization data are stored in the specific memory unit 8. The set-top box is thus ready to read the signals and data of this provider and feed them into the in-home network. It is possible to have more than one provider at the same time. The results of the decompression and the demodulation are passed from the set-top box to the broadband matrix. This matrix may be connected to different output devices in the home, particularly a TV system, but also Internet devices e.a.Webphones and VCRs. Furthermore, the matrix may be connected to a multimedia server via which the output devices are connected to the matrix. Thus, it is possible to connect the input/output devices to the digital matrix directly or via the server. If the server is used, integration of further functions for the in-home wiring and in-home technology is possible. The server also performs functions of security technology and automation, such as system powering. Through the centralization via the server, the in-home functions can also be initiated via each input/output device connected to the server. The input/output devices are connected to the digital matrix or the server by wire or wireless connections.

Since the set-top box is configured only by the initialization, access to all conceivable networks, such as ATM networks, ADSL networks, GSM networks, UMTS networks, etc. is possible. To control access to the in-home network, the use of an input/output device in the form of a card reader is conceivable. The card reader is suitable for reading a smart card and allows access to the in-home network to be controlled via an identification code. The smart card can also be employed in paying charges for requested services.

1. An in-home network for distributing video and/or audio and/or control data, comprising a set-top box (3) for connecting the in-home network to an access networks (2), characterized in that the set-top box includes memory units for storing configuration data from the access networks (2) and is connected on the home side via a digital broadband matrix (4) to a control unit (5) having further inputs and outputs.

2. An in-home network as claimed in claim 1, characterized in that the control unit (5) is incorporated in an in-home server.

3. An in-home network as claimed in claim 1 or 2, characterized in that the server (5) has connections for input and output devices (7).

4. An in-home network as claimed in any one of the preceding claims, characterized in that the server is connected via the digital broadband matrix (4) and the set-top box (3) to different access networks.

5. An in-home network as claimed in any one of the preceding claims, characterized in that the server (5) has inputs and outputs for different control functions of the in-home technology.

6. An in-home network as claimed in any one of the preceding claims, characterized in that the set-top box (3) or the server (5) comprises a card reader (9) for reading a smart card.
